(19) United States
(12) Patent Application Publication
(10) Pub. No.: US 2023/0222752 A1
(43) Pub. Date: Jul. 13, 2023

(54) 3D DISPLAY AND IMAGE PROCESSING METHOD AND ASSOCIATED 3D DISPLAY

(71) Applicant: AUO Display Plus Corporation, Hsinchu City (TW)

(72) Inventors: SIN-GUO JHOU, Hsinchu City (TW); REN-JIE PAN, Hsinchu City (TW); CHIAO-LUNG CHANG, Hsinchu City (TW); CHE-HSIEN CHEN, Hsinchu City (TW)

(21) Appl. No.: 18/121,622

(22) Filed: Mar. 15, 2023

(30) Foreign Application Priority Data
Dec. 12, 2022 (TW) 111147631

(51) Int. Cl. G06T 19/20; G06T 5/20; G06T 5/00

(52) U.S. Cl. CPC G06T 19/20; G06T 5/002; G06T 5/20; G06F 3/04815; G06T 2200/24; G06T 2219/2004; G06T 2219/2016

(57) ABSTRACT

An image processing method suitable for 3D display is provided. The image processing method includes: determining, by a processor in a display-processing element, a current display mode of the 3D display according to a detected user command for activating on-screen display (OSD) menu; in response to the current display mode not being a specific 3D display mode, the processor outputting the OSD menu at a preset position, and outputting an input image; and in response to the current display mode being the specific 3D display mode, the processor outputting the OSD menu at an adjusted position, and outputting the input image, wherein the adjusted position is different from the preset position.

### FIELD OF THE INVENTION

The present invention relates to an application technology suitable for 3D display, and more particularly, to an adjustment method of on-screen display (OSD) menu of a 3D display.

### BACKGROUND OF THE INVENTION

At present, the structure of 3D displays mainly follows that of 2D displays. For example, the display-processing chip in a 3D display may adopt the same display-processing chip in 2D displays, which cannot be directly connected to the 3D display panel. Therefore, a field programmable gate array (FPGA) chip will be additionally arranged between the 3D panel and the display-processing chip, in order to process the 3D format through the FPGA chip, and output the result to the 3D display panel.

Common 3D image formats mainly comprise following three types of 3D modes: line-by-line, side-by-side and top-and-bottom 3D modes. Referring to FIG. 1, which is a schematic diagram of displaying an OSD in a 2D mode, when a user summons the OSD 110 through a remote controller. Then, when the user switches the 2D mode to the side-by-side 3D mode by operating the OSD menu 110, the main screen 100 is separated into a left sub-screen 100L and a right sub-screen 100R. As the OSD menu 110 is generated by the display itself and is a part of the output image but has not undergone 3D processing, when it is converted to 3D display as shown in FIG. 2A, the OSD menu 110 is torn and divided into the first block 110-1 and the second block 110-2. Each of the first block 110-1 and the second block 110-2 contains patterns of different parts of the OSD menu 110. As the contents displayed by the first block 110-1 and the second block 110-2 are different and their positions are also different, the FPGA chip cannot synthesize correct images.

When the user switches the 2D mode to the top-bottom 3D mode by operating the OSD menu 110, the main screen 100 is separated into an upper sub-screen 100U and a lower sub-screen 100B. Similarly, the OSD menu 110 is torn and divided into the first block 110-3 and the second block 110-4, making the FPGA chip unable to synthesize correct images.

To sum up, there is a need for a proper image processing method to solve the above problems encountered in related art techniques, so as to achieve smooth image mode switching and improve the user experience.

### SUMMARY OF THE INVENTION

According to the above requirements, it is an object of the present invention to provide an image processing method suitable for 3D displays and related 3D displays to solve the above problems.

An embodiment of the present invention provides an image processing method suitable for 3D display. The image processing method includes: determining, by a processor in a display-processing element, a current display mode of the 3D display according to a detected user command for activating on-screen display (OSD) menu; in response to the current display mode not being a specific 3D display mode, the processor outputting the OSD menu at a preset position, and outputting an input image; and in response to the current display mode being the specific 3D display mode, the processor outputting the OSD menu at an adjusted position, and outputting the input image, wherein the adjusted position is different from the preset position.

Another embodiment of the present invention provides a 3D display that comprises a display-processing element, a format conversion element and a display panel. The display-processing element comprises a processor that determines a current display mode of the 3D display according to a detected control command for activating an OSD. The format conversion element is coupled to the display-processing element, and arranged to receive an input image and the OSD menu from the display-processing element to generate an output image. The display panel is coupled to the format conversion element, and panel arranged to receive and display the output image from the format conversion element. In response to the current display mode being not a specific 3D mode, the processor outputs the OSD menu at a preset position. In response to the current display mode being the specific 3D mode, the processor outputs the OSD menu at an adjusted position different from the preset position.

To sum up, by adjusting the position of the OSD menu in advance, the present invention avoids the problem of mismatch between the image content and the position of the OSD menu caused by the conversion of the display from 2D mode to 3D mode, so that the user will not see any abnormal images when switching the image modes, thus greatly improving the user experience.

### BRIEF DESCRIPTION OF THE DRAWINGS

FIG. 1 is a diagram illustrating the displaying of an OSD menu in 2D mode.

FIG. 2A is a diagram illustrating the displaying of an OSD menu in a 3D mode.

FIG. 2B is a diagram illustrating the displaying of an OSD menu in another 3D mode.

FIG. 3 is a schematic diagram of a 3D display according to an embodiment of the present invention.

FIG. 4A is a diagram illustrating the displayed image of the 3D display in 2D mode according to an embodiment of the present invention.

FIG. 4B is a diagram illustrating the image processing for a 3D mode according to the 3D display of the present invention.

FIG. 4C is a diagram illustrating an image processing following FIG. 4B.

FIG. 4D is a diagram illustrating the OSD menu after the image processing.

FIG. 4E is a diagram illustrating an image processing for another 3D mode according to the 3D display of the present invention.

FIG. 4F is a diagram illustrating an image processing following FIG. 4E.

FIG. 5 is a flowchart illustrating an image processing method for a 3D display according to an embodiment of the present invention.

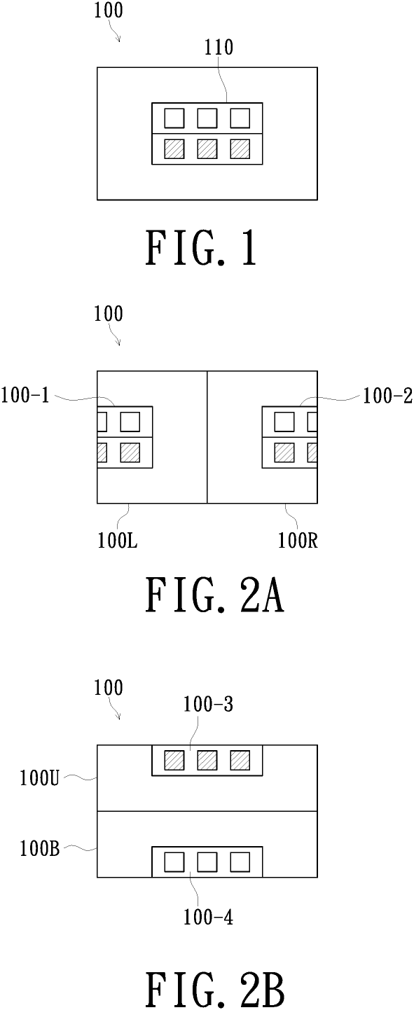

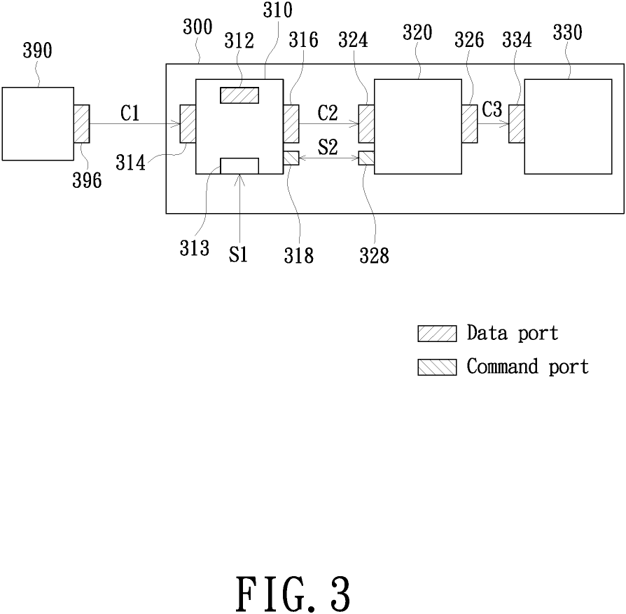

### DETAILED DESCRIPTION OF PREFERRED EMBODIMENTS

The present disclosure is particularly described by following examples that are mainly for illustrative purposes. For those who are familiar with the technologies, various modifications and embellishments can be made without departing from the spirit and scope of the present disclosure, and thus the scope of the present disclosure shall be subject to the content of the attached claims. In the entire specification and claims, unless clearly specified, terms such as “a/an” and “the” can be used to describe “one or at least one” assembly or component. In addition, unless the plural use is obviously excluded in the context, singular terms may also be used to present plural assemblies or components. Unless otherwise specified, the terms used in the entire specification and claims generally have the common meaning as those used in this field. Certain terms used to describe the disclosure will be discussed below or elsewhere in this specification, so as to provide additional guidance for practitioners. The examples throughout the entire specification as well as the terms discussed herein are only for illustrative purposes, and are not meant to limit the scope and meanings of the disclosure or any illustrative term. Similarly, the present disclosure is not limited to the embodiments provided in this specification.

The terms “substantially”, “around”, “about” or “approximately” used herein may generally mean that the error of a given value or range is within 20%, preferably within 10%. In addition, the quantity provided herein can be approximate, which means that unless otherwise stated, it can be expressed by the terms “about”, “nearly”, etc. When the quantity, concentration, or other values or parameters have a specified range, a preferred range, or upper and lower boundaries listed in the table, they shall be regarded as a particular disclosure of all possible combinations of ranges constructed by those upper and lower limits or ideal values, no matter such kind of ranges have been disclosed or not. For example, if the length of a disclosed range is X cm to Y cm, it should be regarded as that the length is H cm, and H can be any real number between x and y.

In addition, the term “electrical coupling” or “electrical connection” may include direct and indirect means of electrical connection. For example, if the first device is described as electrically coupled to the second device, it means that the first device can be directly connected to the second device, or indirectly connected to the second device through other devices or means of connection. In addition, if the transmission and provision of electric signals are described, those who are familiar with the art should understand that the transmission of electric signals may be accompanied by attenuation or other non-ideal changes. However, unless the source and receiver of the transmission of electric signals are specifically stated, they should be regarded as the same signal in essence. For example, if the electrical signal S is transmitted from the terminal A of the electronic circuit to the terminal B of the electronic circuit, which may cause voltage drop across the source and drain terminals of the transistor switch and/or possible stray capacitance, but the purpose of this design is to achieve some specific technical effects without deliberately using attenuation or other non-ideal changes during transmission, the electrical signals S at the terminal A and the terminal B of the electronic circuit should be substantially regarded as the same signal.

The terms “comprising”, “having”, “comprising” and “involving” used herein are open-ended terms, which can mean “comprising but not limited to”. In addition, the scope of any embodiment or claim of the present invention does not necessarily achieve all the purposes, advantages or features disclosed in the present invention. In addition, the abstract and title are only used to assist the search of patent documents, and are not used to limit the scope of claims of the present invention.

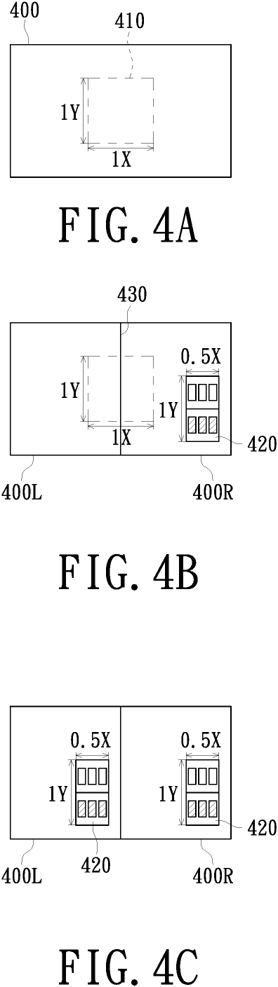

Please refer to FIG. 3, which is a schematic diagram of a 3D display 300 according to an embodiment of the present invention. As shown in FIG. 3, the 3D display 300 comprises a display-processing element 310, a format conversion element 320 and a display panel 330, wherein the format conversion element 320 may be an FPGA chip. The display-processing element 310 comprises a processor 312, a receiving module 313, data interfaces 314 and 316, and an instruction interface 318, wherein the data interface 314 is used to receive image content C1 (e.g., 2D or 3D image content) from the data interface 396 of the image source device 390. The receiving module 313 is coupled to the processor 312 for receiving a control command S1 (e.g., an OSD instruction) for activating the OSD menu, and the processor 312 determines whether the current display mode of the 3D display 300 is 2D mode or 3D mode according to the control command S1 (OSD instruction) received by the receiving module 313. The command interface 318 is used to send or receive an indication signal S2, which may be, for example, a universal asynchronous receiver/transmitter (UART) command.

The image source device 390 may output images in a standard 3D format (e.g., 3D modes such as the line-by-line, side-by-side and top-and-bottom modes). After receiving image data from the image source device 390, the display device 310 may adjust the resolution of the image data (e.g., the resolution may be adjusted to 4K according to the image data). After that, when the receiving module 313 receives the control command S1 (e.g., the OSD instruction) to activate the OSD menu, the display-processing element 310 may send the instruction signal S2 (UART instruction) to the format conversion element 320 through the instruction interface 318, and the format conversion element 320 may convert the image data from 2D mode to having the image format conforming to the display panel 330 according to the 3D format specified in the instruction signal S2 (UART instruction).

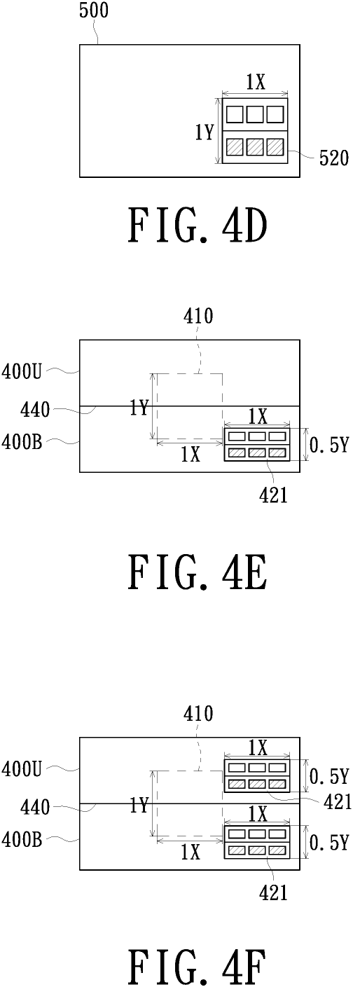

The format conversion element 320 is coupled to the display-processing element 310, and is used for receiving an input image and an OSD menu from the display-processing element 310 to generate an output image C3. The display panel 330 is coupled to the format conversion element 320, and is used for receiving and displaying the output image C3 from the format conversion element 320. If the current display mode is not a specific 3D mode (e.g., the current display mode is the 2D mode or line-by-line 3D mode), the processor 312 will output the OSD menu at a preset position (referring to FIG. 4A) in response to the current display mode. The preset position may be at the center of the input image, somewhere near the center of the input image, or the middle of a particular axial direction, so as to conform to the viewing habits of general users, where the specific 3D mode may mostly refer to the aforementioned side-by-side 3D mode or top-bottom 3D mode, but the present invention is not limited thereto. As long as a 3D mode involves dividing and/or stacking images, it can be viewed as an example of the specific 3D mode defined in the present invention). If the current display mode is a specific 3D mode, e.g., the aforementioned side-by-side 3D mode or top-and-bottom 3D mode, the processor 312 will output the OSD menu in an adjusted position in response to the current display mode, wherein the adjusted position is different from the preset position. Furthermore, the adjusted position should not cross a vertical centerline and/or a horizontal centerline of the main screen, and preferably be located at the corner of the main screen (e.g., the lower-right corner, the lower-left corner, the upper-right corner and the upper-left corner).

It should be noted that if the current display mode is the line-by-line 3D mode or 2D mode, when receiving the control command S1 (OSD instruction) generated by the user for switching to a specific 3D mode through the remote controller or directly pressing the physical key (not shown) of the 3D display 300, the processor 312 can hide the OSD menu before the switching is completed. That is, the displacement operation for the OSD menu will not be displayed on the screen.

In an embodiment of the present invention, the processor 312 outputs the OSD menu at the adjusted position and outputs the input image (jointly represented by the signal C2 in the figure) to the format conversion device 320 in response to the current display mode being a specific 3D mode, wherein the signal C2 is transmitted to the data interface 324 of the format conversion device 320 through the data interface 316 of the display-processing device 310. Then, the format conversion element 320 superimposes the OSD menu with the adjusted position onto the input image as the output image C3, which is then transmitted to the data interface 334 of the display panel 330 through the data interface 326 of the format conversion element 320. In other words, the OSD menu and the input image are first transmitted to the format conversion element 320, and then superimposed by the format conversion element 320. In another embodiment, the processor 312 superimposes the OSD menu with the adjusted position on the input image as a superimposed image, and then transmits the superimposed image to the format conversion element 320. The format conversion element 320 further adjusts the superimposed image according to the adjusted position as the output image C3. In other words, the OSD menu and the input image may be superimposed before being transmitted to the format conversion element 320.

The image processing for the side-by-side 3D mode will be described in details below. Referring to FIG. 4A, which is a diagram illustrating the displayed main screen 400 of the 3D display in the 2D mode according to an embodiment of the present invention. The preset position 410 in the center (as shown in the dotted area) is the position of the display screen menu of the 2D mode. As shown in FIG. 4B, in the side-by-side 3D mode, the main screen 400 is separated into a left sub-screen 400L and a right sub-screen 400R, and the original OSD menu is shrunk and shifted from the preset position 410 and thus becomes an adjusted OSD menu 420, in which the original screen menu has an original scale, with the length and width being 1Y and 1X respectively, where X and Y may be arbitrary values. The adjusted OSD menu 420 has a compressed scale (where the length is kept at Y, and the width is reduced to 0.5X) and be moved to an adjusted position (e.g., the right side or the lower-right corner, nevertheless it must be located within the vertical centerline 430 and cannot cross the vertical centerline 430). Then, in FIG. 4C, the adjusted OSD menu 420 in the right sub-screen 400R is copied to the left sub-screen 400L. The left sub-screen 400L and the right sub-screen 400R are both outputted to the format conversion element 320, and the format conversion element 320 integrates the sub-screens to generate the output image as shown in FIG. 4D, which is displayed through the display panel 330, wherein the OSD menu 520 in the main screen 500 has the original scale with the same size as the dotted area in FIG. 4A. Please note that in a variation of the present invention, the operation of copying the adjusted OSD menu 420 may be omitted, that is, it is possible that only one of the left sub-screen 400L and the right sub-screen 400R contains the adjusted OSD menu 420, but the brightness and/or resolution of the OSD menu in the final synthesized output image will be lower in this manner.

Referring to FIG. 4E and FIG. 4F, when the playback mode is selected as the top-bottom 3D mode, the main screen 400 is separated into an upper sub-screen 400U and a lower sub-screen 400B, and the OSD menu originally located at the preset position 410 is now shifted and shrunk to become an adjusted OSD menu 420, in which the adjusted OSD menu 421 has a compressed scale (with the width being kept at X, and the length being compressed to 0.5Y) and is moved to an adjusted position (which can be the down side or lower-right corner,) Then, in FIG. 4F, the adjusted OSD menu 421 in the lower sub-screen 400B is copied to the upper sub-screen 400U, and later both the upper sub-screen 400U and the lower sub-screen 400B are outputted to the format conversion element 320, and the sub-screens are integrated by the format conversion element 320 to generate an output image (such as the output image as shown in FIG. 4D). Please note that in a variation of the present invention, the operation of copying the adjusted OSD menu 420 can be omitted, that is, only one of the upper sub-screen 400U and the lower sub-screen 400B contains the adjusted OSD menu 420, but the brightness or resolution of the OSD menu in the final synthesized output image will be lower in this manner.

In another embodiment of the present invention, after the main screen generates the two adjacent sub-screens (e.g., aforementioned upper/lower sub-screens or left/right sub-screens), the sub-screens are outputted to the format conversion element 320, and the format conversion element 320 (FPGA chip) will capture the image of the OSD menu located at the preset position 110 as the image of the adjusted position in the output image. That is, compared with the aforementioned embodiments, this embodiment does not pre-shrink the original OSD menu nor copy the sub-screens, instead, the format conversion element 320 forces the image of the original screen menu to replace the image of the adjusted position (e.g., the lower-right corner of the screen), which can achieve similar/same effect as described in the aforementioned embodiments.

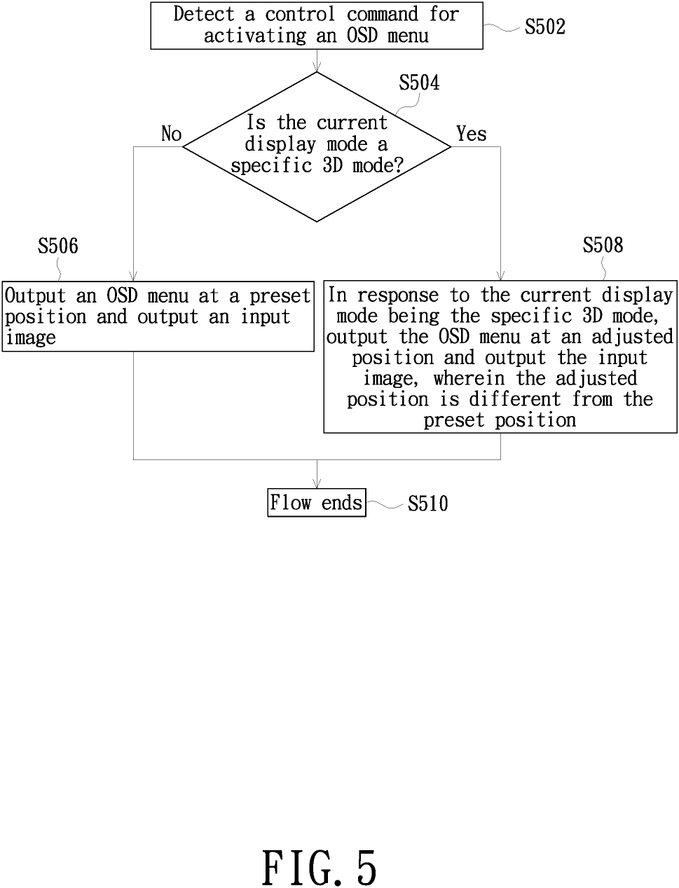

Please refer to FIG. 5, which is a flowchart illustrating an image processing method for a 3D display according to an embodiment of the present invention. Please note that if a substantially same result can be achieved, the described steps need not be executed in the exact sequence provided in FIG. 5. The image processing method shown in FIG. 5 can be applied to the 3D display 300 shown in FIG. 3, and can be realized as following steps.

S502: Detect a control command for activating an OSD menu;

S504: According to the control command, judge the current display mode of the 3D display, and if the current display mode is not a specific 3D mode, the flow goes to S506; otherwise, if the current display mode is the specific 3D mode, the flow goes to step S508;

S506: Output an OSD menu at a preset position and output an input image; the flow goes to step S510;

S508: In response to the current display mode being the specific 3D mode, output the OSD menu at an adjusted position and output the input image, wherein the adjusted position is different from the preset position.

S510: Flow ends.

As those skilled in the art may readily understand the details of each step in FIG. 5 after reading the above paragraphs, further description will be omitted here for brevity.

To sum up, by adjusting the position of the OSD menu in advance, the present invention avoids the problem of mismatch between the image content and the position of the OSD menu caused by the conversion of the display from 2D mode to 3D mode, so that the user will not see any abnormal images when switching the image modes, thus greatly improving the user experience.

Although the present invention has been disclosed by various examples, those are not intended to limit the present invention. Those skilled in the art in the technical field of the present invention can make some changes and embellishments without departing from the spirit and scope of the present invention. Therefore, the scope of protection of the present invention should be as defined in the appended patent application.

What is claimed is:

1. An image processing method suitable for 3D display, comprising following steps:
determining, by a processor in a display-processing element, a current display mode of the 3D display according to a detected user command for activating on-screen display (OSD) menu;
in response to the current display mode not being a specific 3D display mode, the processor outputting the OSD menu at a preset position, and outputting an input image; and
in response to the current display mode being the specific 3D display mode, the processor outputting the OSD menu at an adjusted position, and outputting the input image, wherein the adjusted position is different from the preset position.

2. The image processing method according to claim 1, wherein the preset position is a central position of the input image.

3. The image processing method according to claim 1, wherein when the current display mode is a line-by-line 3D mode or a 2D mode, the processor determines that the current display mode is not the specific 3D mode.

4. The image processing method according to claim 3, wherein when a control command for switching the line-by-line 3D mode or the 2D mode to the specific 3D mode is received, the processor hides the OSD menu before the switching is completed.

5. The image processing method according to claim 1, wherein when the current display mode is a side-by-side 3D mode or a top-and-bottom 3D mode, the processor determines that the current display mode is the specific 3D mode.

6. The image processing method according to claim 1, wherein the step of the processor outputting the OSD menu at the adjusted position in response to the current display mode being the specific 3D mode, comprises:
the processor outputting the OSD menu with the adjusted position and the input image to a format conversion chip coupled to the display-processing element; and
the format conversion element superimposing the OSD menu with the adjusted position onto the input image as an output image.

7. The image processing method according to claim 1, wherein in response to the current display mode being the specific 3D mode, the step of the processor outputting the OSD menu at the adjusted position comprises:
the processor superimposing the OSD menu with the adjusted position on the input image as a superimposed image;
the processor transmitting the superimposed image to a format conversion element coupled to the display-processing element; and
the format conversion element using the superimposed image as an output image.

8. The image processing method according to claim 1, wherein the OSD menu is of an original scale, and when the specific 3D mode is a side-by-side 3D mode or a top-and-bottom 3D mode, the step of the processor outputting the OSD menu at the adjusted position comprises:
generating two adjacent sub-screens according to a main screen respectively;
pre-shrinking and shifting the OSD menu to a corner of one sub-screen of the sub-screens, to generate an adjusted OSD menu;
copying the adjusted OSD menu to a corresponding conner of the other sub-screen of the sub-screens, wherein the adjusted OSD menu does not cross a vertical midline and/or a horizontal midline that separates the main screen into the sub-screens; and
outputting the sub-screens to the format conversion element, and integrating the sub-screens by the format conversion element to generate an output image, wherein the OSD menu on the output image is of the original scale.

9. The image processing method according to claim 8, wherein when the specific 3D mode is the side-by-side 3D mode, the sub-screens are a left sub-screen and a right sub-screen respectively, and the step of pre-shrinking and shifting the OSD menu to a corner of one sub-screen of the sub-screens, to generate an adjusted OSD menu comprises:
moving the OSD menu to the right or lower-right corner of the right sub-screen, and pre-shrink the proportion of the right sub-screen in the horizontal direction to half of the original proportion.

10. The image processing method according to claim 8, wherein when the specific 3D mode is the top-bottom 3D mode, the sub-screens are an upper sub-screen and a lower sub-screen, respectively, and the step of shifting and pre-shrinking the OSD menu to generate the adjusted one in one of the sub-screens comprises:
moving the OSD menu to a lower side or a lower-right corner of the lower sub-screen, and vertically pre-shrinking the right sub-screen to half of its original scale.

11. The image processing method according to claim 1, wherein the OSD menu has an original scale, and when the specific 3D mode is a side-by-side 3D mode or a top-and-bottom 3D mode, the step of the processor outputting the OSD menu at the adjusted position comprises:
respectively generating adjacent sub-screens according to a main screen; and
outputting the sub-screens to the format conversion element, and integrating the sub-screen by the format conversion element to generate an output image, wherein the OSD menu on the output image is of an original scale, and the format conversion element captures the image of the OSD menu located at the preset position as the image of the adjusted position on the output image, and the adjusted position does not cross a vertical midline and/or a horizontal midline that seperates the main screen into the sub-screens.

12. A 3D display comprising:
a display-processing element comprising a processor, wherein the processor determines a current display mode of the 3D display according to a detected control command for activating an on-screen display (OSD);
a format conversion element coupled to the display-processing element, the format conversion element arranged to receive an input image and the OSD menu from the display-processing element to generate an output image; and
a display panel coupled to the format conversion element, the display panel arranged to receive and display the output image from the format conversion element;
wherein in response to the current display mode being not a specific 3D mode, the processor outputs the OSD menu at a preset position; and in response to the current display mode being the specific 3D mode, the processor outputs the OSD menu at an adjusted position different from the preset position.
